(19) United States
(12) Patent Application Publication
(10) Pub. No.: US 2010/0177083 A1
(43) Pub. Date: Jul. 15, 2010

(54) ACTIVE-MATRIX TYPE DISPLAY DEVICE AND AN ELECTRONIC APPARATUS HAVING THE SAME

(75) Inventor: Keitaro Yamashita, Kobe (JP)

Correspondence Address: LIU & LIU, 444 S. FLOWER STREET, SUITE 1750, LOS ANGELES, CA, 90071, US

(73) Assignee: TPO Displays Corp., Chu-Nan (TW)

(21) Appl. No.: 12/652,717

(22) Filed: Jan. 5, 2010

(30) Foreign Application Priority Data
Jan. 9, 2009 (JP) 2009-003172

(51) Int. Cl. G06F 3/038; G09G 3/20; G09G 3/36; G09G 3/32

(52) U.S. Cl. 345/211; 345/55; 345/98; 345/82

(57) ABSTRACT

A display device whose pixels being embedded with a memory is disclosed. These pixels each includes: a capacitor; a switching unit between the display unit and the capacitor, being turning on during the sampling period; and a voltage detecting circuit for detecting the voltage between the capacitor and the switching unit. Besides, the display unit also includes: a first capacitor voltage source connected to a terminal of the capacitor which is not connected to the voltage detecting circuit, and applying a predetermined voltage within the variation range of the voltage state of the display unit on the capacitor in the sampling period; and/or a second capacitor voltage source, being connected to a terminal of the display unit which is not connected to the switching unit, and applying a predetermined voltage within the variation range of the voltage state of the display unit on the display unit in the sampling period.

### BACKGROUND OF THE INVENTION

1. Field of the Invention

The present invention relates to an active-matrix type display device including a plurality of pixels arranged in a matrix form consisting of lines and rows, and an electronic apparatus having the active-matrix type display device.

2. Description of Related Art

In the conventional active-matrix type display device, the driver thereof continuously writing the data into the pixel, regarding the active-matrix type display device is in the dynamic image display mode or in the static image display mode. Thus, while the active-matrix type display device is in the static image display mode, data is frequently written into the pixel. As a result, the idea has been proposed for including a memory in each pixel, for providing the data written into the pixel while the active-matrix type display device is in the static image display mode. Thus, the data write-in process of the driver can thus be substituted, and the power-consumption can also be decreased, as described in [Patent Document 1 JP 2007-328351]. This technology is called as MIP (Memory In Pixel).

Generally, in the MIP technology, for maintaining the data stored in the memory of each pixel, a DRAM (Dynamic Random Access Memory) or a SRAM (Static Random Access Memory) is used. The SRAM consists of a circuit, which has plural transistors arranged in sequence. The DRAM consists of a transistor and a capacitor. Thus, the DRAM is preferred in the respect of minimizing the covering area of the circuit and reducing the spacing between the pixels. However, for maintaining the small charge stored in the capacitor of the DRAM, a refreshing process has to be executed regularly. An example of the pixel circuit using the DRAM therein can be found in International Patent Application No. WO2004/090854A1 [Patent Document 2].

FIG. 1 illustrated that the constitution of a conventional DRAM. The DRAM includes a transistor Q1 and a capacitor C1, wherein the source of the transistor Q1 is connected to the bit line 11, while the gate of the transistor Q1 is connected to the wording line 12. One terminal of the capacitor C1 is connected to the drain of the transistor Q1, while the other terminal of the capacitor C1 is grounded. During the “write-in” process, the transistor Q1 is turn on when a voltage being applied on the gate of the transistor Q1 at the beginning. Then, the capacitor C1 is received the “1” of a binary data of bit line 11 through the transistor Q1, for storing voltage equivalent at the capacitor C1. In this way, with the charging or discharging of the capacitor C1, the DRAM can be used as a 1-bit memory for memorizing the data represented by “1” or “0”.

In practical usage, the connecting point located between the drain of the transistor Q1 and the capacitor C1 is further connected to a transistor Q2 (not shown in the figure). The transistor Q2 is used as a voltage detecting component, for detecting whether the voltage of the terminal of the capacitor, which is connected to the gate of the transistor Q2, is above a predetermined value. Once the transistor Q1 is turned on according the wording line 12, then an input voltage Vᵢₙ is applied on the capacitor C1. At this time, a voltage Vₛ equivalent to the input voltage Vᵢₙ is applied on the gate of the transistor Q2, for turning on the transistor Q2.

In the case that the conventional DRAM is used, the voltage value detected by the voltage detecting component will be affected by the component characteristic, such as the threshold voltage, of the component used as the voltage detecting component.

### SUMMARY OF THE INVENTION

For solving the problem, the object of the present invention is to provide an active-matrix type display device with its pixels being embedded with a memory, having the characteristic independent from the characteristic of the voltage detecting component and being operated stably, and an electronic apparatus having the aforementioned active-matrix type display device.

To achieve the object, the active-matrix type display device of the present invention, including a plurality of pixels arranged in a matrix form consisting of lines and rows, characterized in: the plurality of pixels, each including: a display unit; a capacitor, for memorizing the voltage state of the display unit being in a high level or in a low level; a switching unit, being connected to the display unit and the capacitor and turned on during a sampling period in which the voltage state of the capacitor is memorized; and a voltage detecting circuit, for detecting the voltage between the capacitor and the switching unit. Besides, the display unit also includes; a first capacitor voltage source, being connected to a terminal of the capacitor which is not connected to the voltage detecting circuit, and applying a predetermined voltage within the variation range of the voltage state of the display unit on the capacitor in the sampling period; and/or a second capacitor voltage source, being connected to a terminal of the display unit which is not connected to the switching unit, and applying a predetermined voltage within the variation range of the voltage state of the display unit on the display unit in the sampling period.

Thus, by applying a predetermined voltage on the terminal of the capacitor of an MIP pixel not being connected to the voltage detecting circuit, and/or to the terminal of the display unit not being connected to the switching unit, an active-matrix type display device with pixels being embedded with a memory, having the characteristic independent from the characteristic of the voltage detecting component and being operated stably is thus provided.

The active-matrix type display device of the present invention further comprises a source driver providing data to the plurality of pixels through a source line. The source driver is used as the first capacitor voltage source. The capacitor is connected to the source driver through the source line. Besides, the second capacitor voltage source can be connected to a common driver of the plurality of pixels through a common electrode line.

Therefore, no dedicated voltage source circuit and line are required in the active-matrix type display device of the present invention, which makes the constitution of the active-matrix type display device of the present invention remain in the same scale.

The voltage detecting circuit is an n-type transistor or a p-type transistor. It can also be an inverter circuit or a differential amplifying circuit.

That is, any circuit capable of responding to the voltage applied thereon can be used, based on the usage of the circuit, as the aforementioned voltage detecting circuit.

Moreover, the active-matrix type display device of the present invention can be a display device using the liquid cell as the luminant display unit included in its pixel, or an OLED display device using the organic EL.

Besides, the active-matrix type display device of the present invention can be assembled in a portable apparatus driven by battery, such as a mobile phone, a PDA, a portable audio player, and a portable game player, whose operation is limited by the power consumption, and the electronic device, such as the monitor displaying commercial advertisements like posters.

The present invention provides an active-matrix type display device with pixels being embedded with a memory, having the characteristic independent from the characteristic of the voltage detecting component and being operated stably, and an electronic apparatus having the aforementioned active-matrix type display device.

Other objects, advantages, and novel features of the invention will become more apparent from the following detailed description when taken in conjunction with the accompanying drawings.

### BRIEF DESCRIPTION OF THE DRAWINGS

FIG. 1 illustrated that the constitution of a conventional DRAM.

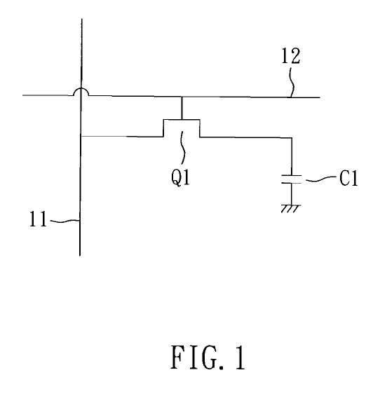

FIG. 2 illustrated that the layout of the active-matrix type display device according to the embodiment of the present invention.

FIG. 3 is illustrated a simplified pixel circuit of the active-matrix type display device according to the embodiment of the present invention.

FIG. 4 is a timing diagram showing the operation of the pixel circuit of FIG. 3.

FIG. 5 illustrated that the voltage-resistor relationship of an n-type transistor.

FIG. 6 illustrated that the constitution of a source driver according to the embodiment of the present invention.

FIG. 7 is a timing diagram showing the operation of the pixel circuit of FIG. 3 in another example.

FIG. 8 illustrated that the voltage detecting circuit of the pixel circuit according to the embodiment of the present invention.

FIG. 9 illustrated that an electronic apparatus including the active-matrix type display device according to the embodiment of the present invention.

### DETAILED DESCRIPTION OF THE PREFERRED EMBODIMENT

The preferred embodiment of the present invention will be described, accompanying with the figures below:

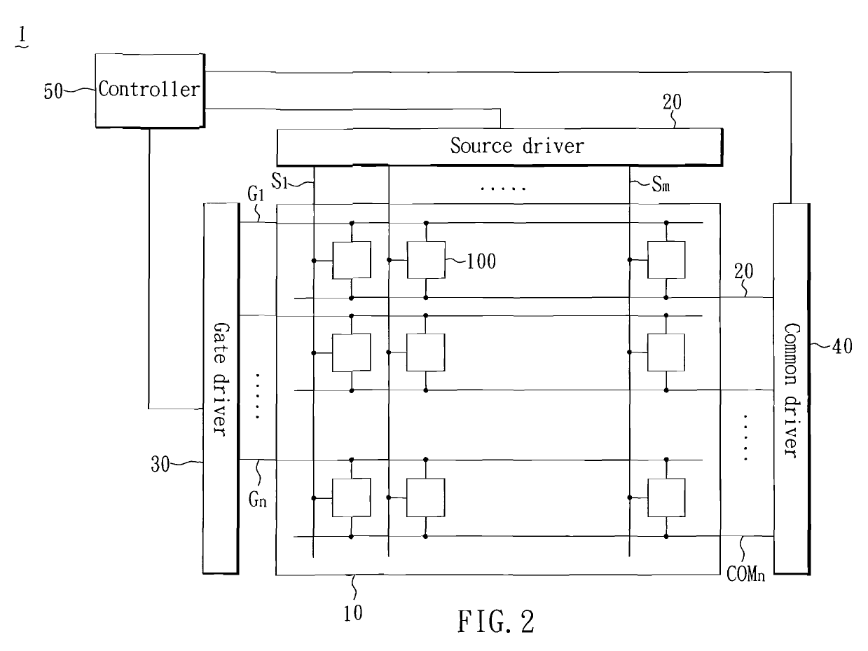

FIG. 2 illustrated that the layout of the active-matrix type display device according to the embodiment of the present invention. As shown in FIG. 2, the display device 1 includes a display unit 10, a source driver 20, a gate driver 30, a common driver 40, and a controller 50.

The display unit 10 includes a plurality of pixels 100 arranged in a matrix form consisting of lines and rows. The source driver 20 is connected to the plurality of pixels through the source lines S₁˜Sₘ. The image data is provided to the plurality of pixels in analog form or in digital form. The gate driver 30 controls the on/off state of each of the plurality of the pixels through the gate lines G₁˜Gₙ. The common driver 40 is connected to the plurality of the pixels through the common lines COM₁˜COMₙ. The common driver 40 changes the voltage level of the common lines COM₁˜COMₙ based on the driving state of each of the plurality of the pixels. The controller 50 controls the operation of these drivers by synchronizing the source driver 20, gate driver 30 and common driver 40.

In display unit 10, each of the plurality of the pixels 100 is located in a region crossed by the source lines S₁˜Sₘ and the gate lines G₁˜Gₙ, and includes at least one display unit (for example, a liquid crystal cell or an organic EL) and a corresponding memory in pixel. In the static image display mode, each of the plurality of the pixels is operated based on the data memorized in the embedded therein, instead of the data transmitted to the each of the plurality of the pixels through the source lines S₁˜Sₘ. Therefore, in the static image display mode, the display unit 10 can continuously display a static image, even though the source driver 20 is stopped from operation.

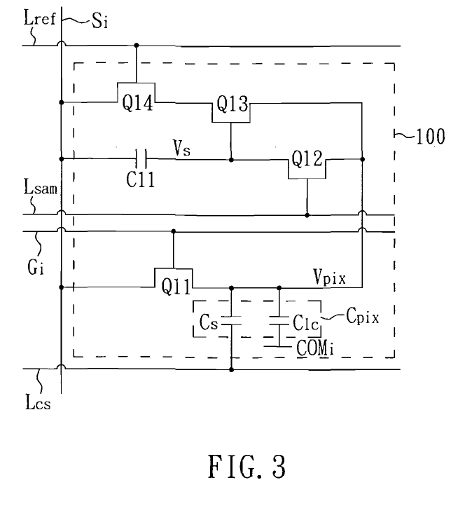

FIG. 3 is illustrated a simplified pixel circuit of the active-matrix type display device according to the embodiment of the present invention.

The pixel 100 shown in FIG. 3 includes a pixel capacity Cₚᵢₓ and a first transistor Q11, the pixel capacity Cₚᵢₓ includes the display unit C_{lc}, (such as the liquid crystal cell) and a storage capacitor Cₛ. One terminal of the display unit C_{lc} is connected to the common electrode line COMᵢ, while the other terminal of the display unit C_{lc} is connected to the source line Sᵢ through the first transistor Q11. Besides, one terminal of the storage capacitor Cₛ is connected to the storage capacity line L_{cs}, while the other terminal of the storage capacitor Cₛ is connected to the source line Sᵢ through the first transistor Q11.

Alternatively, the storage capacitor Cₛ can be connected to the common electrode line COMᵢ or the gate line in the next row G₍ᵢ₋₁₎, instead of the storage capacity line L_{cs}. Once the gate driver 30 controls the first transistor Q11 to be at the on state through the gate line Gᵢ, for applying the voltage of the source line Sᵢ on the display unit C_{lc}, making the display unit C_{lc} emit light. At this time, the light passing the liquid crystal will be deviated. Although in FIG. 3, the display unit C_{lc} is represented by the capacity component, such as a liquid crystal cell, a light emitting diode, such as an OLED can also be used as the display unit C_{lc}.

As shown in FIG. 3, pixel 100 can further include a second transistor Q12, a third transistor Q13, a fourth transistor Q14 and a sampling capacitor C11, wherein one terminal of the sampling transistor C11 is connected to the source line Sᵢ, while the other terminal of the sampling transistor C11 is connected to a connecting point located between the display unit C_{lc} and the first transistor Q11, through the second transistor Q12. The gate of the second transistor Q12 is connected to the sampling line Lₛₐₘ. The third transistor Q13 and the fourth transistor Q14 are connected to each other in series. The third transistor Q13 is further connected to a connecting point located between the display unit C_{lc} and the first transistor Q11. Besides, the gate of the third transistor Q13 is connected to a connecting point located between the sampling transistor C11 and the second transistor Q12. Moreover, the gate of the fourth transistor Q14 is connected to a refresh line L_{ref}. The aforementioned sampling transistor C11, the second transistor Q12, the third transistor Q13 constitute a DRAM (Dynamic Random Access Memory), wherein the third transistor Q13 operates as the voltage detecting component.

Hereinafter, a normal black type liquid crystal display device will be used as the display device of the present invention. An inverse driving action for displaying a white area will be used as an example, for describing the action of the pixel circuit shown in FIG. 3.

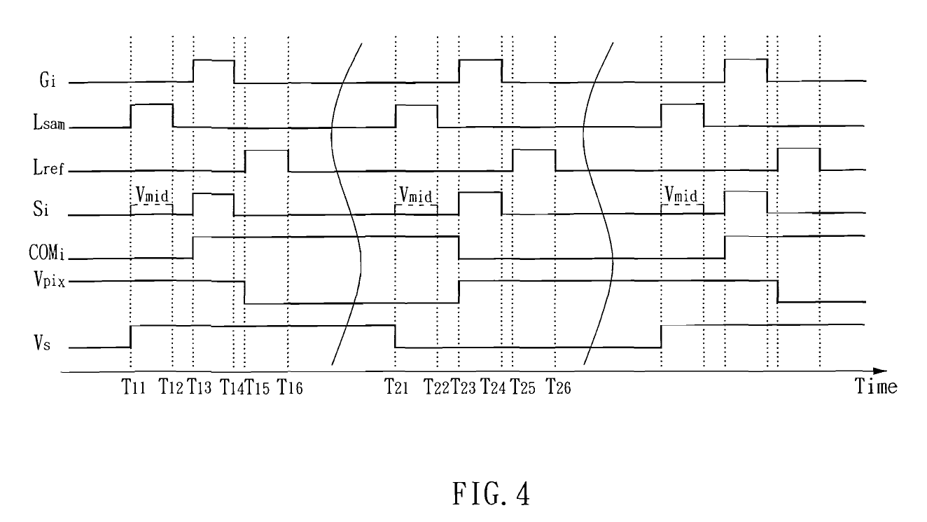

FIG. 4 is a timing diagram showing the operation of the pixel circuit of FIG. 3. At the beginning condition (˜T₁₁), the voltage of the terminal of the pixel capacity Cₚᵢₓ which is connected to the source line Sᵢ through the first transistor Q11, which will be called as the pixel voltage Vₚᵢₓ below, is in the high level, such as 5 volts. Besides, the voltage of the other terminal of the pixel capacity Cₚᵢₓ (i.e. the voltage of the common electrode line COMᵢ), which is enabled by the common driver 40, is at the low level, such as 0 volts. At this time, the first transistor Q11, the second transistor Q12, the third transistor Q13, and the fourth transistor Q14 are all at the off state.

Then, at time T₁₁, for sampling the current pixel voltage Vₚᵢₓ, the controller 50 controls the sampling line Lₛₐₘ to be in the high level. At this time, the second transistor Q12 is in the off state. As a result, the voltage between the second transistor Q12 and the sampling transistor C11, which will be called as the sampling voltage Vₛ below, is in the high level (=5 volts). Later, at time T₁₂, even though the sampling line Lₛₐₘ is in the low level, the sample voltage Vₛ can be maintained in the high level by the capacitor C11.

Moreover, during the sampling period when the sampling line Lₛₐₘ is in the high level (i.e. T₁₁˜T₁₂), a predetermined intermediate voltage V_{mid}, which is between the high level and the low level, (for example, 1.25 volts) is applied on the source line Sᵢ by the source driver 20.

Then, in the T₁₃˜T₁₄ period, for pre-charging the pixel capacity Cₚᵢₓ, the gate driver 30 enables the gate line Gᵢ to be in the high level. At the same time, the source driver 20 enables the source line Sᵢ to be in the high level. Meanwhile, the first transistor Q11 is turned on, for connecting the pixel capacity Cₚᵢₓ with the source line Sᵢ. Besides, at the beginning moment of the pre-charging period (T₁₃), the common driver 40 enables the common electrode line COMᵢ at the high level.

After the pre-charging period (T₁₃˜T₁₄) is finished, i.e. at time T₁₅, the controller 50 enables the refresh line L_{ref} to be in the high level. At this time, the fourth transistor Q14 is turned on. By this way, the source of the third transistor Q13 is connected to the source line Sᵢ. Once the pre-charging period (T₁₃˜T₁₄) is finished, the source driver 20 enables the source line Sᵢ to be in the low level (=0 volts). As a result, the source of the third transistor Q13 is also in the low level (=0 volts). Moreover, since the voltage of the source line Sᵢ is the intermediate voltage V_{mid} during the sampling period T₁₁˜T₁₂, the gate of the third transistor Q13 has the sampling voltage Vₛ=Vₚᵢₓ−V_{mid}, and the third transistor Q13 is thus turned on. That is, the pixel capacity Cₚᵢₓ is connected to the source line Sᵢ through the third transistor Q13 and the fourth transistor Q14. The pixel voltage Vₚᵢₓ is in the low level (=0 volts). After that, at time T₁₆, the refresh line L_{ref} is enabled to be in the low level again.

Finally, the pixel voltage Vₚᵢₓ and the common voltage V_{com} are inversed from their original state, respectively. That is, the high level and the low level of these two voltages are mutually exchanged.

At this time, for sampling the current pixel voltage Vₚᵢₓ at the next sample time T₂₁, the controller 50 controls the sampling line Lₛₐₘ to be in the high level. Meanwhile, the second transistor Q12 is turned on. Therefore, the sampling voltage Vₛ between the second transistor Q12 and the sampling capacitor C11 is connected to the pixel capacity Cₚᵢₓ, and in the low level (=0 volts). After that, at time T₂₂, the sampling line Lₛₐₘ is enabled to be in the low level.

Moreover, during the sampling period T₂₁˜T₂₂, in which sampling line Lₛₐₘ is enabled to be in the high level, a predetermined intermediate voltage V_{mid}, which is between the high level and the low level, (for example, 1.25 volt) is applied on the source line Sᵢ by the source driver 20.

Then, in the T₂₃˜T₂₄ period, for pre-charging the pixel capacity Cₚᵢₓ, the gate driver 30 enables the gate line Gᵢ to be in the high level. At the same time, the source driver 20 enables the source line Sᵢ to be in the high level. Meanwhile, the first transistor Q11 is turned on, for connecting the pixel capacity Cₚᵢₓ with the source line Sᵢ. Therefore, the pixel voltage Vₚᵢₓ is in the high level. Besides, at the beginning moment of the pre-charging period (T₂₃), the common driver 40 enables the common electrode line COMᵢ to be in the low level.

After the pre-charging period (T₂₃˜T₂₄) is finished, i.e. at time T₂₅, the controller 50 controls the refresh line L_{ref} to be in the high level. At this time, the fourth transistor Q14 is turned on. By this way, the source of the third transistor Q13 is connected to the source line Sᵢ. Once the pre-charging period (T₂₃˜T₂₄) is finished, the source driver 20 enables the source line Sᵢ to be in the low level (=0 volt). As a result, the source of the third transistor Q13 is also in the low level (=0 volt). Moreover, since the voltage of the source line Sᵢ is the intermediate voltage V_{mid} during the sampling period T₂₁˜T₂₂, the gate of the third transistor Q13 has the sampling voltage Vₛ=Vₚᵢₓ−V_{mid}<0V. Therefore, the third transistor Q13 remains at the off state. After that, at time T₂₆, the refresh line L_{ref} is enabled to be in the low level.

Finally, the pixel voltage Vₚᵢₓ and the common voltage V_{com} are inversed once again, respectively. That is, the high level and the low level of these two voltages are mutually exchanged again, returning to their original state, respectively.

That is, in the pixel circuit according to the embodiment of the present invention, a predetermined intermediate voltage V_{mid}, which is between the high level and the low level, (for example, 1.25 volt) is applied on the terminal of the sampling capacitor C11 other than the aforementioned terminal connected to pixel capacity, through the source line Sᵢ during the sampling period. Hereinafter, the necessity of applying the aforementioned intermediate voltage V_{mid} during the sampling period will be described.

Before the sampling period, i.e. before the pixel capacity Cₚᵢₓ being connected to the sampling capacitor C11, the total charge Q₀ of the circuit is represented by:

Q₀=Cₚᵢₓ(Vₚᵢₓ−V_{com})+C11(Vₛ−V_{Si})

wherein, V_{Si} is the voltage of the source line Sᵢ.

Then, during the sampling period, i.e. in the period that the second transistor Q12 is turned on for connecting the pixel capacity Cₚᵢₓ with the sampling capacitor C11, the total charge Q₀ of the circuit is represented by:

Qₛ=Cₚᵢₓ(V₀−V_{com})+C11(V₀−V_{Si})

wherein, V₀ is the voltage between the pixel capacity Cₚᵢₓ and the sampling capacitor C11 (in this condition, V₀=Vₚᵢₓ=Vₛ).

At this time, due to the law of the conversation of charge Q₀=Qₛ, the voltage V₀ is as follows:

V₀=(Vₚᵢₓ+Vₛ·C11/Cₚᵢₓ)/(1+C11/Cₚᵢₓ)

In general, C11/Cₚᵢₓ˜0, so the voltage is further represented as:

V₀=Vₚᵢₓ

Therefore, during the sampling period, the charge Q₁ stored in the sampling capacitor C11 is as follows:

Q₁=C11(Vₚᵢₓ−V_{Si})=C11(Vₚᵢₓ−V_{mid})

Since the second transistor Q12 is turned off after the sampling period has finished, the sampling capacitor C11 still stores the charge therein.

After that, during the refreshing period, the voltage V_{Si} of the source line Sᵢ will be 0 volts even though the second transistor is maintained at the off state. At this time, if the sampling voltage Vₛ becomes V_{g}, then according to the law of the conversation of charge, the formula below will be effective.

Q₁=C11(Vₚᵢₓ−V_{mid})=C11(V_{g}−0)

As a result, the voltage V_{g} can be represented by:

V_{g}=Vₚᵢₓ−V_{mid}

Thus, during the refreshing period, the sampling voltage V_{g} is decreased with an amount equivalent to the predetermined voltage V_{mid} applied through the source line Sᵢ during the sampling period.

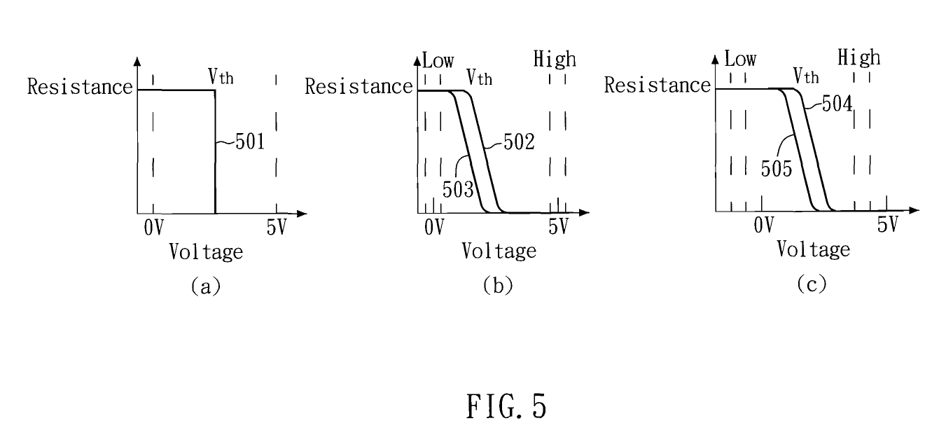

FIG. 5 illustrated that the voltage-resistor relationship of an n-type transistor. The curve 501 in FIG. 5(a) illustrated that the variation of the resistor as the voltage increases and passes the predetermined threshold voltage Vₜₕ, and the variation of the resistor as the voltage decreases and passes the predetermined threshold voltage Vₜₕ, wherein the predetermined threshold voltage Vₜₕ is about 0.6 volts. Thus, the switching between the on state and the off state of the transistor, in which the resistor is not obliquely varied around the threshold voltage Vₜₕ, is mostly preferred. However, the actual voltage-resistor relationship of a transistor, as shown by the curve 502 and curve 503 in FIG. 5(b), the resistor is changed gradually like a gentle slope at the switching between the on state and the off state of the transistor. Moreover, difference in voltage-resistor relationships occurs between different transistors, or between different slots of the transistors, as shown by the aforementioned curve 502 and curve 503. The n-type transistor, especially the third transistor Q13 used in the pixel circuit according to the embodiment of the present invention, as shown by the curve 503 of FIG. 5(b), the operation at the resistor low side is not stable. Thus, the voltage detected by the voltage detecting component will be limited by the threshold voltage of the transistor used as the voltage detecting component. However, as shown by the curve 504 and curve 505 of FIG. 5(c), this problem can be overcome by moving the detecting voltage applied on the gate of the transistor to the center of the variation range thereof.

Thus, the pixel circuit according to the embodiment of the present invention applies the predetermined intermediate voltage V_{mid} on the terminal of sampling transistor C11 other than the aforementioned terminal connected to the pixel capacity Cₚᵢₓ through the source line Sᵢ. Thus, the pixel circuit according to the embodiment of the present invention can be operated stably, not being limited by the threshold voltage of the third transistor Q13, which is used as a voltage detecting component.

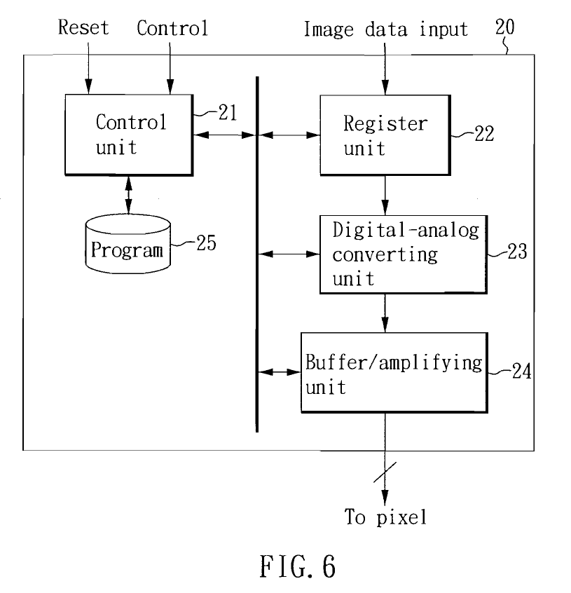

FIG. 6 illustrated that the constitution of a source driver according to the embodiment of the present invention.

As shown in FIG. 6, source driver 20 includes a control unit 21, a register unit 22, a digital-analog converting unit (D/A) 23, and a buffer/amplifying unit 24, wherein the control unit 21 can control the operation of each component of the source driver 20 based on the program 25 stored in the embedded memory or in the external memory. Besides, the register unit 22 can store the digital image data provided by the controller (not shown in the figure) of the display device temporarily. The digital-analog converting unit 23 can transfer the digital data signal output by the register unit 22 into a corresponding analog signal. Finally, the buffer/amplifying unit 24 can buffer and amplify the analog data signal output by the digital-analog converting unit 23, or the digital data signal directly output by the register unit 22. The buffer/amplifying unit 24 then outputs the signal to each of the pixels of the display unit through the source line S₁˜Sₘ. Moreover, during the sampling period of the pixel circuit, the digital-analog converting unit 23 provides the predetermined intermediate voltage V_{mid} to the source line Sᵢ, in response to the signal from the control unit 21.

That is, the source driver 20 of the present embodiment is connected to the terminal of the sampling capacitor C11 (whose voltage state is in the high level or in the low level) of an MIP display unit, which is not connected to the display unit. Thus, during the sampling period T₁₁˜T₁₂, a first capacitor voltage source applies a predetermined voltage V_{mid} within the variation range of the voltage state of the display unit on the capacitor C11.

Alternatively, a dedicated capacitor voltage source different from the source driver 20 and a dedicated line different from the source line Sᵢ can also be included, for applying a predetermined intermediate voltage V_{mid} on the capacitor C11. The technological feature is beneficial for the case, in which the specification of the source driver cannot be changed.

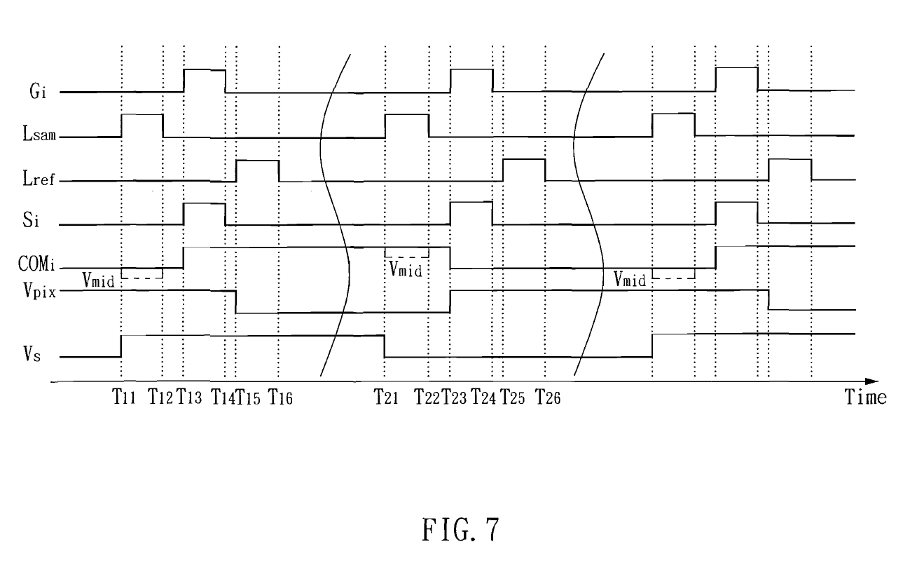

FIG. 7 is a timing diagram showing the operation of the pixel circuit of FIG. 3 in another example.

The difference between the example shown in FIG. 7 and the example shown in FIG. 4 is as follows:

In the example shown in FIG. 7, the intermediate voltage V_{mid} is applied on the common electrode line COMᵢ, rather than the source line Sᵢ. Moreover, in the present example, the intermediate voltage V_{mid} has a negative value (<0).

Before the sampling period, i.e. before the pixel capacity Cₚᵢₓ is connected to the sampling capacitor C11, the total charge Q₀ of the circuit is represented by:

Q₀=Cₚᵢₓ(Vₚᵢₓ−V_{com})+C11(Vₛ−V_{Si})

wherein, V_{Si} is the voltage of the source line Sᵢ.

Then, during the sampling period, i.e. in the period that the second transistor Q12 is turned on for connecting the pixel capacity Cₚᵢₓ with the sampling capacitor C11, the total charge Q₀ of the circuit is represented by:

Qₛ=Cₚᵢₓ(V₀−V_{com}−V_{mid})+C11(V₀−V_{Si})

wherein, V₀ is the voltage between the pixel capacity Cₚᵢₓ and the sampling capacitor C11 (in this condition, V₀=Vₚᵢₓ=Vₛ).

At this time, due to the law of the conversation of charge Q₀=Qₛ, the voltage V₀ is as follows:

V₀=(Vₚᵢₓ+V_{mid}+Vₛ·C11/Cₚᵢₓ)/(1+C11/Cₚᵢₓ)

In general, C11/Cₚᵢₓ˜0, so the voltage is further represented as:

V₀=Vₚᵢₓ+V_{mid}

Therefore, during the sampling period, the charge Q₁ stored in the sampling capacitor C11 is as follows:

Q₁=C11(Vₚᵢₓ+V_{mid}−V_{Si})

Since the second transistor Q12 is turned off after the sampling period has finished, the sampling capacitor C11 still stores the charge therein.

After that, during the refreshing period, the voltage V_{Si} of the source line Sᵢ will be 0 volts even though the second transistor is maintained at the off state. At this time, if the sampling voltage Vₛ becomes V_{g}, then according to the law of the conversation of charge, the formula below will be effective.

Q₁=C11(Vₚᵢₓ+V_{mid}−V_{Si})=C11(V_{g}−0)

As a result, the voltage V_{g} can be represented by:

V_{g}=Vₚᵢₓ+V_{mid}

Thus, during the refreshing period, the sampling voltage V_{g} is increased with an amount equivalent to the predetermined intermediate voltage V_{mid} applied through the common electrode line COMᵢ by the common driver 40 during the sampling period. But, in the present example, since the intermediate voltage V_{mid} has a negative value, so the sampling voltage V_{g} is actually decreased with an amount equivalent to the intermediate voltage V_{mid}. Thus, with reference to FIG. 5, the pixel circuit according to the embodiment of the present invention can be operated stably, not being limited by the threshold voltage of the third transistor Q13, which is used as a voltage detecting component.

In other words, the common driver 40 of the present embodiment is connected to the terminal of the display unit C_{lc}, which is not connected to the sampling capacitor C11 (whose voltage state is in the high level or in the low level) of an MIP display unit. Thus, during the sampling period T₁₁˜T₁₂, a second capacitor voltage source applies a predetermined voltage V_{mid} within the variation range of the voltage state of the display unit on the display unit C_{lc}.

Alternatively, a dedicated capacitor voltage source different from the common driver 40 and a dedicated line different from the common electrode line COMᵢ can also be included, for applying a predetermined intermediate voltage V_{mid} on the display unit C_{lc}. The technologic feature is beneficial for the case, in which the specification of the common driver cannot be changed.

In the above embodiment, although an n-type transistor is used as a voltage detecting component, a p-type transistor or the circuit described below can also be used to replace the voltage detecting component.

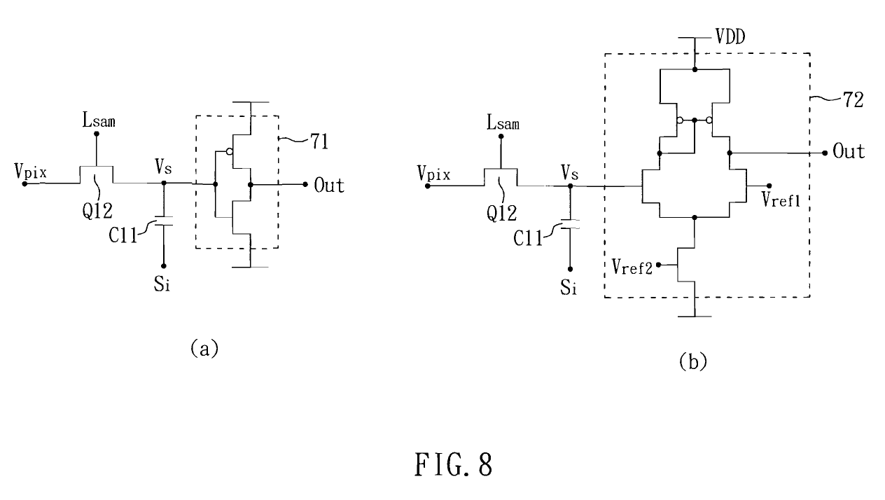

FIG. 8 illustrated that the voltage detecting circuit of the pixel circuit according to the embodiment of the present invention. In FIG. 8, for the ease of understanding, only the DRAM circuit formed in the pixel circuit and the voltage detecting circuit connected to the output of the DRAM circuit are depicted.

FIG. 8(a) illustrated that an inverter circuit 71 in the pixel circuit shown in FIG. 3, which is consisted of a p-type transistor and an n-type transistor, for being used as a voltage detecting circuit, and replacing the third transistor Q13 used as the voltage detecting component. As shown in FIG. 8(a), the output “Out” of the inverter circuit 71 is connected to a connecting point located between the display unit C_{lc} and the first transistor Q11.

Besides, FIG. 8(b) illustrated that a differential amplifying circuit 72 in the pixel circuit shown in FIG. 3, which is consisted of a current mirror circuit and a constant current circuit, for being used as a voltage detecting circuit, and replacing the third transistor Q13 used as the voltage detecting component. As shown in FIG. 8(b), the output “Out” of the differential amplifying circuit 72 is connected to a connecting point located between the display unit C_{lc} and the first transistor Q11.

A predetermined intermediate voltage V_{mid} is applied on either voltage detecting circuit 71 or voltage detecting circuit 72, through the source line Sᵢ or the common electrode line COMᵢ, for varying at the center of the variation range of the detecting voltage.

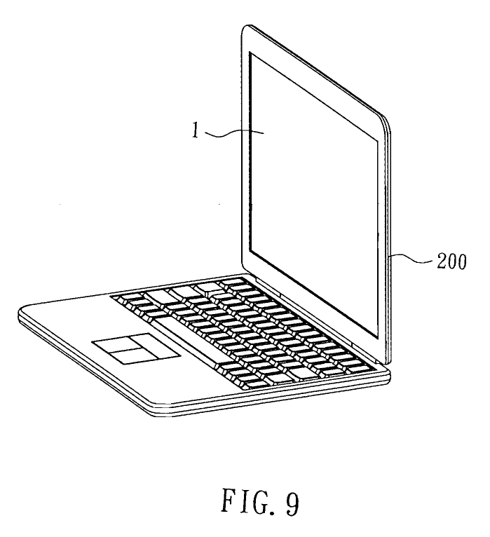

FIG. 9 illustrated that an electronic apparatus including the active-matrix type display device according to the embodiment of the present invention.

Although in FIG. 9, the electronic apparatus 200 is shown as a tablet PC, the electronic apparatus 200 can alternatively be an electronic apparatus such as a mobile phone, a PDA, a car navigation system, or a portable game player. As shown in FIG. 9, the electronic apparatus 200 includes a display device 1 having a display module for displaying images.

Although the present invention has been explained in relation to its preferred embodiment, it is to be understood that many other possible modifications and variations can be made without departing from the scope of the invention as hereinafter claimed.

For example, although in the above embodiment, for describing the variation at the center of the variation range of the detecting voltage, an intermediate voltage V_{mid} is applied through one of the source lines Sᵢ or one of the common electrode lines COMᵢ. However, the intermediate voltage V_{mid} can be applied through both the one of the source lines Sᵢ and the one of the common electrode lines COMᵢ at the same time.

What is claimed is:

1. An active-matrix type display device, including:
a plurality of pixels arranged in a matrix form consisting of lines and rows, wherein the plurality of pixels, each including:
a display unit;
a capacitor, for memorizing the voltage level of the display unit being in a high level or in a low level;
a switching unit, being connected to the display unit and the capacitor and turned on during a sampling period in which the voltage state of the capacitor is memorized; and
a voltage detecting circuit, for detecting the voltage between the capacitor and the switching unit;
besides, the display unit also including;
a first capacitor voltage source, being connected to a terminal of the capacitor which is not connected to the voltage detecting circuit, and applying a predetermined voltage within the variation range of the voltage state of the display unit on the capacitor in the sampling period; and/or
a second capacitor voltage source, being connected to a terminal of the display unit which is not connected to the switching unit, and applying a predetermined voltage within the variation range of the voltage state of the display unit on the display unit in the sampling period.

2. The active-matrix type display device as claimed in claim 1, wherein the first capacitor voltage source includes a source driver providing data to the plurality of pixels through a source line, and the source line is connected to the capacitor.

3. The active-matrix type display device as claimed in claim 1, wherein the display device further comprises a common driver being connected to the second capacitor voltage source and the plurality of pixels through a common electrode line.

4. The active-matrix type display device as claimed in claim 1, wherein the voltage detecting circuit is an n-type transistor or a p-type transistor.

5. The active-matrix type display device as claimed in claim 1, wherein the voltage detecting circuit is an inverter circuit.

6. The active-matrix type display device as claimed in claim 1, wherein the voltage detecting circuit is a differential amplifying circuit.

7. A liquid crystal display device includes the active-matrix type display device as claimed in claim 1.

8. An OLED display device includes the active-matrix type display device as claimed in claim 1.

9. An electronic apparatus includes the active-matrix type display device as claimed in claim 1.
